(19) United States
(12) Patent Application Publication
(10) Pub. No.: US 2020/0154161 A1
(43) Pub. Date: May 14, 2020

(54) SMART TELEVISION AND SET-TOP BOX CONTROL SYSTEM

(71) Applicant: ZHEJIANG DUSUN ELECTRON CO., LTD., Huzhou, Zhejiang (CN)

(72) Inventor: Xiang WU, Huzhou, Zhejiang (CN)

(73) Assignee: ZHEJIANG DUSUN ELECTRON CO., LTD., Huzhou, Zhejiang (CN)

(21) Appl. No.: 16/614,350

(22) PCT Filed: May 17, 2017
(86) PCT No.: PCT/CN2017/084685

§ 371 Date: Nov. 15, 2019

(51) Int. Cl. H04N 21/422

(52) U.S. Cl. CPC H04N 21/42207; H04N 21/42203

(57) ABSTRACT

A smart television and set-top box control system and method. The system comprises: an EPG application connected with the smart television and a set-top box and a remote controller comprising a control protocol matching the smart television and a control protocol matching the set-top box; the remote controller is used for receiving an input control instruction, converting the control instruction into a play instruction by using a corresponding control protocol, and transmitting the play instruction to the EPG application; when an EPG generated by the EPG application is located on a live interface, the play instruction is converted by using the control protocol of the set-top box; when the EPG is located on a video-on-demand interface, the play instruction is converted by using the control protocol of the smart television; and the EPG application is used for generating the EPG and controlling the smart television and the set-top box to execute the play instruction. A trouble of switching programs is removed by using the EPG mode, and one single remote controller can implement control over the smart television and the set-top box.

### FIELD

The present disclosure relates to the field of television technology, and in particular to a system for controlling a smart TV and a set-top box.

### BACKGROUND

At present, smart TVs and network set-top boxes are highly popular in people's daily life. People can use smart TVs and network set-top boxes to watch TV programs on demand and watch replays. However, there are some people who still want to watch the live TV programs from Broadcast Television Network. Therefore, there is a need to switch between the network TV and the live TV during user's viewing process. Currently, different remote controllers are used for switching control, which is very troublesome and degrades user experience.

Therefore, how to control both the smart TV and the set-top box by using one remote controller is a technical problem that a person skilled in the art needs to solve.

### SUMMARY

An object of the present disclosure is to provide a system and method for controlling a smart TV and a set-top box, which adopts EPG to solve the problem of inconvenience in switching programs, and realizes the control over the smart TV and the set-top box by using one remote controller.

In order to solve the above technical problem, the present disclosure provides a system for controlling a smart TV and a set-top box, the system including: an EPG application connected to both the smart TV and the set-top box, and a remote controller including a control protocol matching the smart TV and a control protocol matching the set-top box;

the remote controller is configured to receive a control command inputted, convert the control command into a play command by using a corresponding control protocol, and send the play command to the EPG application, where in a case that an EPG generated by the EPG application is located on a live broadcast interface, the remote controller uses the control protocol of the set-top box for conversion into the play command, and in a case that the EPG is located on an on-demand service interface, the remote controller uses the control protocol of the smart TV for conversion into the play command; and

the EPG application is configured to generate the EPG and control the smart TV and the set-top box to execute the play command.

In an embodiment, in a case that the control protocol of the set-top box is an infrared control protocol, the EPG application downloads an infrared code, and sends the infrared code to the remote controller.

In an embodiment, in a case that the control protocol of the smart TV is a Bluetooth control protocol, the remote controller communicates with the smart TV through a Bluetooth chip.

In an embodiment, the remote controller includes a posture chip for receiving posture information inputted and converting the posture information into a corresponding control command.

In an embodiment, the remote controller includes a touch chip for receiving touch information inputted and converting the touch information into a corresponding control command.

In an embodiment, the remote controller includes a microphone for receiving voice information inputted and converting the voice information into a corresponding control command.

The present disclosure also provides a method for controlling a smart TV and a set-top box, the method including:

receiving a control command inputted, converting the control command into a play command by using a corresponding control protocol, and sending the play command to an EPG application, by a remote controller, where, in a case that an EPG generated by the EPG application is located on a live broadcast interface, the conversion into the play command is performed by using a control protocol of the set-top box, and in a case that the EPG is located on an on-demand service interface, the conversion into the play command is performed by using a control protocol of the smart TV; and

controlling, by the EPG application, the smart TV and the set-top box to execute the play command.

In an embodiment, in a case that the control protocol of the set top box is an infrared control protocol, the EPG application downloads an infrared code and sends the infrared code to the remote controller.

In an embodiment, in a case that the control protocol of the smart TV is a Bluetooth control protocol, the remote controller communicates with the smart TV through a Bluetooth chip.

In an embodiment, receiving the control command inputted, by the remote controller, includes:

receiving posture information inputted and converting the posture information into a corresponding control command, by the remote controller; and/or,

receiving touch information inputted and converting the touch information into a corresponding control command, by the remote controller; and/or,

receiving voice information inputted and converting the voice information into a corresponding control command, by the remote controller.

The present disclosure provides a system for controlling a smart TV and a set-top box, the system including: an EPG application connected to a smart TV and a set-top box, and a remote controller including a control protocol matching the smart TV and a control protocol matching the set-top box. The remote controller is configured for receiving a control command inputted, converting the control command into a play command by using a corresponding control protocol, and sending the play command to the EPG application, where in a case that an EPG generated by the EPG application is located on a live broadcast interface, the remote controller uses the control protocol of the set-top box for conversion into the play command, and in a case that the EPG is located on an on-demand service interface, the remote controller uses the control protocol of the smart TV for conversion into the play command. The EPG application is used to generate the EPG and control the smart TV and the set-top box to execute the play command.

It can be seen that the system adopts EPG to display an on-demand program and a live broadcast interface together through an electronic interface menu, which is convenient for a user to select a program, thereby solving the problem of inconvenience in switching programs. Moreover, the remote controller in the system has a control protocol of the smart TV and a control protocol of the set-top box; therefore the system can realize the control over the smart TV and the set-top box by using only one remote controller, which is convenient for user operation and improves user experience. The present disclosure also provides a method for controlling a smart TV and a set-top box, which also has the above beneficial effects.

### BRIEF DESCRIPTION OF THE DRAWINGS

For clearer illustration of the technical solutions according to embodiments of the present disclosure or conventional art, the drawings in embodiments of the present disclosure or conventional art are briefly described hereinafter. Apparently, the drawings in the following descriptions are only some embodiments of the present disclosure, and other drawings may be obtained by those skilled in the art based on the provided drawings without creative efforts.

FIG. 1 is a structural block diagram of a system for controlling a smart TV and a set-top box according to an embodiment of the present disclosure;

FIG. 2 is a schematic diagram of a connection pattern of a BMI160 chip according to an embodiment of the present disclosure;

FIG. 3 is a schematic diagram of a connection pattern of an MXT224 chip according to an embodiment of the present disclosure;

FIG. 4 is a schematic diagram of a connection pattern of a microphone according to an embodiment of the present disclosure; and

FIG. 5 is a flowchart of a method for controlling a smart TV and a set-top box according to an embodiment of the present disclosure.

### DETAILED DESCRIPTION

The core of the present disclosure is to provide a system and method for controlling a smart TV and a set-top box, which adopts EPG to solve the problem of inconvenience in switching programs, and realizes the control over the smart TV and the set-top box by using one remote controller.

Hereinafter technical solutions in embodiments of the present disclosure are described clearly and completely in conjunction with the drawings in embodiments of the present closure, so that the objects, technical solutions and advantages of embodiments of the present disclosure can be clearer. Apparently, the described embodiments are only some rather than all of the embodiments of the present disclosure. Any other embodiments obtained based on the embodiments of the present disclosure by those skilled in the art without any creative effort fall within the scope of protection of the present disclosure.

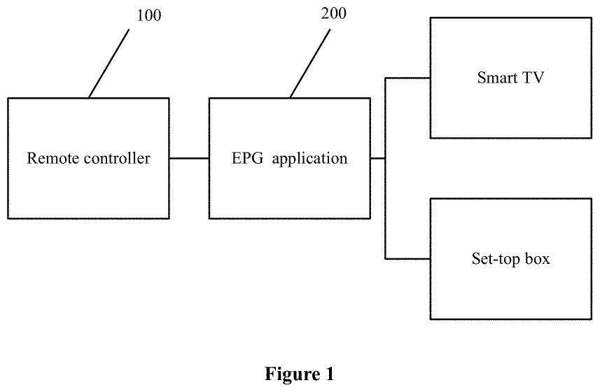

In the embodiments, the network television (i.e., on-demand program) and the live television (i.e., live program) can be perfectly combined by means of EPG by which desired content for view can be selected more conveniently and clearly, and the control over a smart TV and a set-top box can be achieved by using one remote controller, thereby facilitating user's operation. For details, reference is made to FIG. 1. FIG. 1 is a structural block diagram of a system for controlling a smart TV and a set-top box according to an embodiment of the present disclosure. The system may include:

an EPG application 200 connected to both the smart TV and the set-top box, and a remote controller 100 including a control protocol matching the smart TV and a control protocol matching the set-top box;

the remote controller 100 is configured to receive an control command inputted, convert the control command into a play command by using a corresponding control protocol, and send the play command to the EPG application, where in a case that an EPG generated by the EPG application is located on a live broadcast interface, the control protocol of the set-top box is used for conversion into the play command, and in a case that the EPG is located on an on-demand service interface, the control protocol of the smart TV is used for conversion into the play command;

the EPG application 200 is configured to generate the EPG and control the smart TV and the set-top box to execute the play command.

This embodiment does not limit the control protocol of the smart TV and the control protocol of the set-top box, which may be set according to actual needs. For example, the control protocols may be Bluetooth or other RF (such as 2.4G, RF4CE or Wi-Fi) protocols. This embodiment only defines that the remote controller 100 has the control protocol of the smart TV and the control protocol of the set-top box, such that the remote controller 100 can realize the control over the smart TV and the set-top box according to the corresponding control protocol. For example, when the control protocol of the smart TV is the Bluetooth protocol and the control protocol of the set-top box is an infrared protocol, the remote controller 100 has both the Bluetooth protocol and the infrared protocol.

This embodiment does not limit the position of the EPG application 200 either. The EPG application 200 may be set in the smart TV or in the set-top box, which can generate an EPG (Electronic Program Guide), form an electronic interface menu APP and execute program selection according to the command sent by the remote controller 100. If a current EPG is located on the live broadcast interface, the EPG application 200 switches an input source to a live broadcast source, the corresponding control protocol is the control protocol corresponding to the set-top box, and the remote controller 100 uses the control protocol of the set-top box to perform the conversion into the play command, to realize the control over the set-top box, such that the smart TV plays content of a TV channel desired by the user. If the current EPG is located on the on-demand service interface, the EPG application 200 switches the input source to an on-demand service source, the corresponding control protocol is the control protocol corresponding to the smart TV, and the remote controller 100 uses the control protocol of the smart television to perform the conversion into the play command, to realize the control over the smart TV, such that the smart TV plays a TV program desired by the user.

Further, in order to ensure the reliability and timeliness of the EPG, the EPG application 200 may download an updated EPG in real time or at fixed time instants (for example, the EPG may be downloaded from a cloud).

The remote controller 100 is mainly configured to receive a control command inputted by a user, and convert the control command into a play command by using a corresponding control protocol. In an embodiment, if the current EPG is located on the live broadcast interface, the control command is converted into the play command according to content of the control protocol of the set-top box. If the current EPG is located on the on-demand service interface, the control command is converted into the play command according to content of the control protocol of the smart TV.

The method for obtaining the control command is not limited in this embodiment. For example, the control command may be obtained by voice conversion, or the control command may be obtained by posture information conversion, or the control command may be obtained by touch information conversion, or the control command may be obtained by key conversion. For example, in a case that the remote controller has a key, the user operates the key, and the key triggers a corresponding signal, where the signal is converted into a control command that is recognizable by a machine. In a case that the remote controller has a voice input function, the user inputs a voice, and the remote controller may extract a keyword from the voice, determine an electronic signal corresponding to the keyword, and convert the electronic signal into a control command that is recognizable by a machine.

Based on the above technical solution, the system for controlling a smart TV and a set-top box according to the embodiment of the present disclosure adopts EPG to display the on-demand program and the live broadcast interface together through the electronic interface menu, which is convenient for the user to select the program and solve the problem of inconvenience in switching programs. Moreover, the remote controller in the system has the control protocol of the smart TV and the control protocol of the set-top box; therefore the system can realize the control over the smart TV and the set-top box by using only one remote controller, which is convenient for user operation and improves the user experience, and can ensure the reliability of the EPG

Since most of the set-top boxes currently on the market communicate with the outside world by using the infrared protocol, in an embodiment based on the above embodiment, in a case that the control protocol of the set-top box is an infrared control protocol, the EPG application 200 downloads an infrared code and sends the infrared code to the remote controller 100.

In this embodiment, the EPG application 200 may download the infrared code (for example, the infrared code may be downloaded from a cloud) in real time, at fixed time instants or on receiving an infrared code update signal.

In this embodiment, the EPG application 200 downloads the infrared code and sends the infrared code to the remote controller 100, so that the remote controller 100 has a correct infrared code, which saves the cumbersome infrared learning. Further, in a case that the infrared code is stored in the cloud, different broadcast TV set-top boxes (infrared-controlled devices) in various regions may also obtain the correct control code from the cloud conveniently by positioning, which also saves the cumbersome infrared learning.

That is, this embodiment uses the advantage of the Internet to place the EPG with the huge data and the infrared code libraries of various different devices, i.e., different set-top boxes, in the cloud, and the required code library and an EPG update may be downloaded from the cloud in real time or on demand during usage, so that a variety of infrared devices can be supported. Nationwide or even worldwide, quick control is supported on any infrared device that is in the infrared code library.

Based on the above embodiment, in a case that the control protocol of the smart TV is a Bluetooth control protocol, the remote controller 100 communicates with the smart TV through a Bluetooth chip.

The system adopts EPG to solve the problem of inconvenience in switching programs. Moreover, both of Bluetooth protocol and infrared protocol are added in the remote controller 100, so as to control both the smart TV and the set-top box (infrared-controlled devices), which is convenient user operation and improves user experience.

In an embodiment, the Bluetooth chip herein may be a CSR1011, which is not limited in this embodiment, and any chip having a Bluetooth communication function may be used. The Bluetooth chip can realize Bluetooth master control and IR conversion. That is, the Bluetooth chip CSR1011 is used to communicate with the smart TV (i.e., the television) through the Bluetooth protocol. The remote controller 100 has two protocols, and can control the smart TV through the Bluetooth protocol, and at the same time control the infrared device (for example, the set-top box) by downloading the code library from the APP, i.e., the EPG application 200.

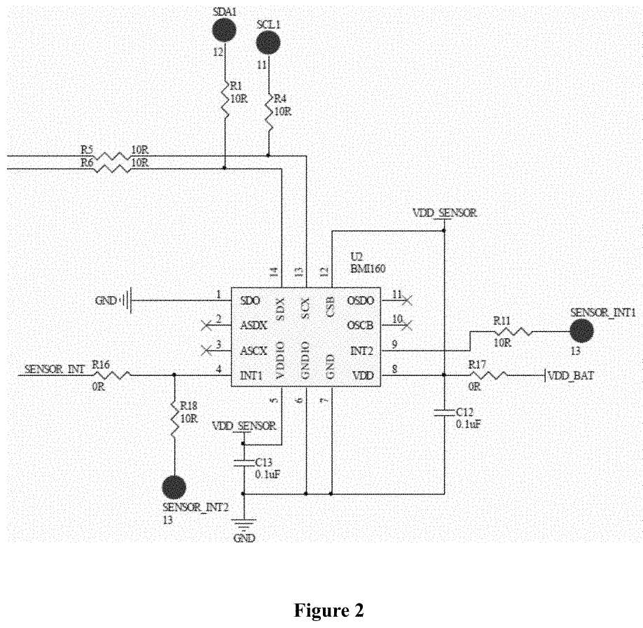

Based on any of the above embodiments, in order to improve the user experience in using the remote controller and enhance the fun of use, the remote controller 100 may have an air mouse function, which, for example, can realize selection operation on the EPG by the user's body posture. The remote controller 100 in an embodiment may have a posture chip. For example, the remote controller 100 in the embodiment may include a 6-axis gyroscope BMI 160 for receiving posture information inputted and converting the posture information into a corresponding control command. That is, the 6-axis gyroscope BMI160 (or any other chip with an identical function) can be used to realize the air mouse function for quick selection operation. The 6-axis gyroscope BMI160 may convert the obtained posture information into a corresponding electronic signal and convert the electronic signal into a control command that is recognizable by the machine. Reference can be made to FIG. 2 which shows a connection pattern of the BMI160 chip.

Based on any of the above embodiments, in order to improve the user experience in using the remote controller and enhance the fun of use, in an embodiment, the remote controller 100 may include a touch chip for receiving touch information inputted and converting the touch information into a corresponding control command. That is, the remote controller 100 has a touch function, so that the user can perform operations such as quick page turning by touching an operation panel. The touch chip may convert the obtained touch information into a corresponding electronic signal, and convert the electronic signal into a control command which is recognizable by the machine. The touch chip is not specifically limited in this embodiment.

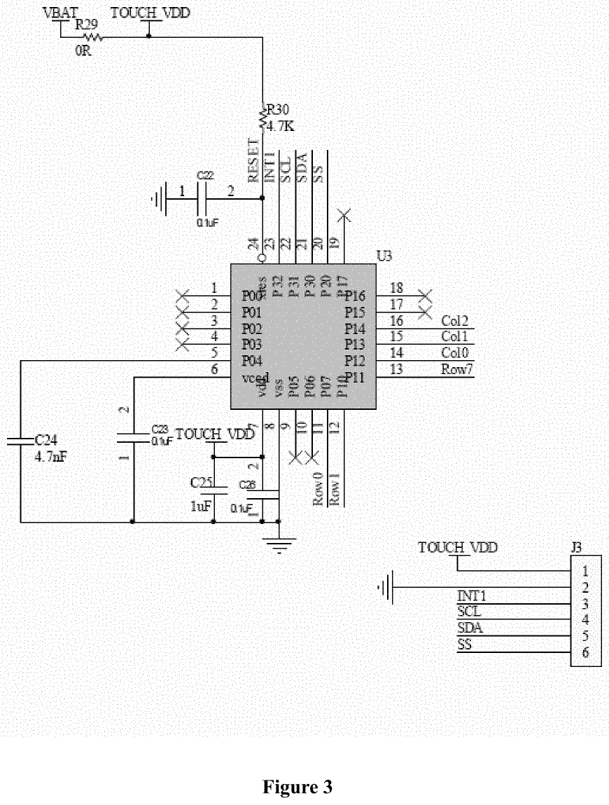

In an embodiment, the touch chip may be an MXT224. Reference can be made to FIG. 3 which shows a connection pattern of the MXT224 chip. Quick page turning operation is realized by using the touch chip MXT224.

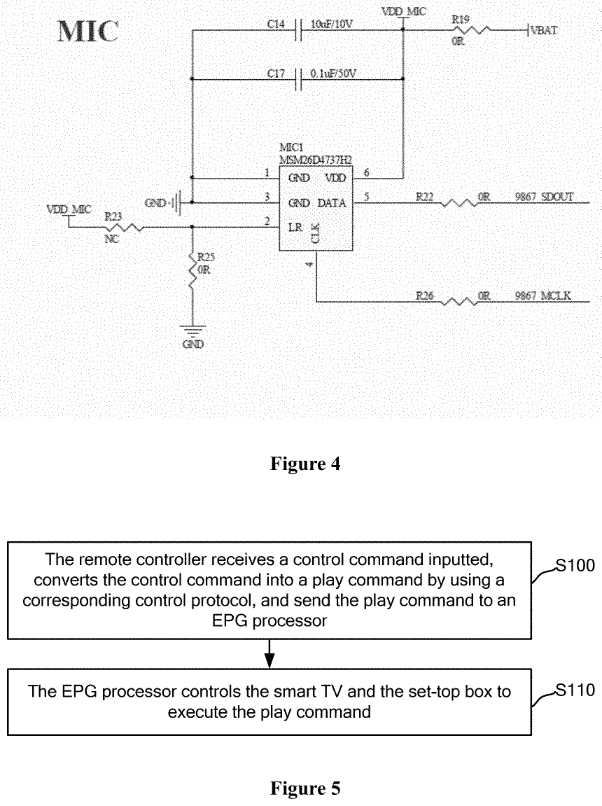

Based on any of the foregoing embodiments, in order to improve the user experience in using the remote controller and enhance the fun of use, the remote controller in an embodiment may include a microphone for receiving voice information inputted and converting the voice information into a corresponding control command. That is, the remote controller 100 has a voice function, so that the user can realize a quick search or control over the EPG by a voice operation. The remote controller 100 may extract a keyword from the voice, determine an electronic signal corresponding to the keyword, and convert the electronic signal into a control command that is recognizable by the machine. For example, a microphone is used for voice input to assist in voice recognition on the smart TV side, to realize a voice search function. The TV program desired by the user can be quickly located by voice search, so as to improve the efficiency of user selection. Reference can be made to FIG. 4 which shows a connection pattern of the microphone MIC.

Further, in order to enhance the applicability of the remote controller 100 and satisfy user's various control manners, the remote controller 100 may simultaneously have at least two of key input, voice input (for example, by MIC), posture input (for example, by BMI160) and touch input (for example, by MXT224) functions.

A method for controlling a smart TV and a set-top box according to an embodiment of the present disclosure is described hereinafter. Cross reference can be made to the method for controlling a smart TV and a set-top box described hereinafter and the system for controlling a smart TV and a set-top box described above.

Reference is made to FIG. 5. FIG. 5 is a flowchart of a method for controlling a smart TV and a set-top box according to an embodiment of the present disclosure. The method may include steps S100 and S110.

In S100, a remote controller receives a control command inputted, converts the control command into a play command by using a corresponding control protocol, and sends the play command to an EPG application. In a case that an EPG generated by the EPG application is located on a live broadcast interface, the remote controller uses a control protocol of the set-top box to perform the conversion into the play command. In a case that the EPG is located on the on-demand service interface, the remote controller uses a control protocol of the smart TV to perform the conversion into the play command.

In S110, the EPG application controls the smart TV and the set-top box to execute the play command.

Specifically, in the embodiment, the remote controller has both the control protocol of the smart TV and the control protocol of the set-top box.

Based on the above technical solution, the method for controlling a smart TV and a set-top box according to the embodiment of the present disclosure adopts EPG to display an on-demand program and a live broadcast interface together through an electronic interface menu, which is convenient for a user to select a program, thereby solving the problem of inconvenience in switching programs. Moreover, the remote controller in the method has a control protocol of the smart TV and a control protocol of the set-top box; therefore the method can realize the control over the smart TV and the set-top box by using only one remote controller, which is convenient for user operation and improves user experience.

Based on the above embodiment, in a case that the control protocol of the set-top box is an infrared control protocol, the EPG application downloads an infrared code and sends the infrared code to the remote controller.

Based on the above embodiment, in a case that the control protocol of the smart TV is a Bluetooth control protocol, the remote controller communicates with the smart TV through a Bluetooth chip.

Based on any of the above embodiments, the remote controller receives the control command inputted may include:

the remote controller receives posture information inputted and converts the posture information into a corresponding control instruction; and/or,

the remote controller receives touch information inputted and converts the touch information into a corresponding control instruction; and/or,

the remote controller receives voice information inputted and converts the voice information into a corresponding control command.

Specifically, in the embodiment, the remote controller may have a conversion function for at least one of the above-mentioned information (posture information, touch information and voice information).

The embodiments of the present disclosure are described in a progressive manner, and each embodiment places emphasis on the difference from other embodiments. Therefore, one embodiment can refer to other embodiments for the same or similar parts. Since devices disclosed in the embodiments correspond to methods disclosed in the embodiments, the description of the devices is simple, and reference may be made to the relevant part of the methods.

A person skilled in the art will further appreciate that elements and algorithm steps of various examples described in conjunction with the embodiments disclosed herein may be implemented in electronic hardware, computer software or a combination thereof. In order to clearly illustrate interchangeability of the hardware and software, composition and steps of the various examples have been generally described in terms of function in the above description. Whether these functions are performed in hardware or software depends on specific application and design constraints of the technical solution. A person skilled in the art may use different methods for implementing the described functions for each particular application, but such implementation should not be considered beyond the scope of the present disclosure.

The steps of the method or algorithm described in conjunction with the embodiments disclosed herein may be implemented directly in hardware, a software module executed by a processor, or a combination thereof. The software module may be disposed in a random access memory (RAM), internal storage, read only memory (ROM), electrically programmable ROM, electrically erasable programmable ROM, register, hard disk, portable disk, CD-ROM, or any other form of storage medium known in the technical field.

The system and method for controlling a smart TV and a set-top box according to the present disclosure are described above. The principles and implementations of the present disclosure have been described herein with reference to specific examples, and the description of the above embodiments is only to assist in understanding the method of the present disclosure and its core idea. It should be noted that those skilled in the art can make various improvements and modifications to the present disclosure without departing from the spirit and scope of the present disclosure and that the improvements and the modifications shall also fall within the scope of the claims of the present disclosure.

1. A system for controlling a smart TV and a set-top box, the system comprising: an EPG application connected to both the smart TV and the set-top box, and a remote controller comprising a control protocol matching the smart TV and a control protocol matching the set-top box, wherein:
the remote controller is configured to receive a control command inputted, convert the control command into a play command by using a corresponding control protocol, and send the play command to the EPG application, wherein, in a case that an EPG generated by the EPG application is located on a live broadcast interface, the remote controller uses the control protocol of the set-top box for conversion into the play command, and in a case that the EPG is located on an on-demand service interface, the remote controller uses the control protocol of the smart TV for conversion into the play command; and
the EPG application is configured to generate the EPG, and control the smart TV and the set-top box to execute the play command.

2. The system for controlling a smart TV and a set-top box according to claim 1, wherein in a case that the control protocol of the set-top box is an infrared control protocol, the EPG application downloads an infrared code and sends the infrared code to the remote controller.

3. The system for controlling a smart TV and a set-top box according to claim 2, wherein in a case that the control protocol of the smart TV is a Bluetooth control protocol, the remote controller communicates with the smart TV through a Bluetooth chip.

4. The system for controlling a smart TV and a set-top box according to claim 1, wherein the remote controller comprises a posture chip for receiving posture information inputted and converting the posture information into a corresponding control command.

5. The system for controlling a smart TV and a set-top box according to claim 1, wherein the remote controller comprises a touch chip for receiving touch information inputted and converting the touch information into a corresponding control command.

6. The system for controlling a smart TV and a set-top box according to claim 1, wherein the remote controller comprises a microphone for receiving voice information inputted and converting the voice information into a corresponding control command.

7. A method for controlling a smart TV and a set-top box, the method comprising:
receiving a control command inputted, converting the control command into a play command by using a corresponding control protocol, and sending the play command to an EPG application, by a remote controller, wherein, in a case that an EPG generated by the EPG application is located on a live broadcast interface, the conversion into the play command is performed by using a control protocol of the set-top box, and in a case that the EPG is located on an on-demand service interface, the conversion into the play command is performed by using a control protocol of the smart TV; and
controlling, by the EPG application, the smart TV and the set-top box to execute the play command.

8. The method for controlling a smart TV and a set-top box according to claim 7, wherein in a case that the control protocol of the set top box is an infrared control protocol, the EPG application downloads an infrared code and sends the infrared code to the remote controller.

9. The method for controlling a smart TV and a set-top box according to claim 8, wherein in a case that the control protocol of the smart TV is a Bluetooth control protocol, the remote controller communicates with the smart TV through a Bluetooth chip.

10. The method for controlling a smart TV and a set-top box according to claim 7, wherein receiving the control command inputted, by the remote controller, comprises:
receiving posture information inputted and converting the posture information into a corresponding control command, by the remote controller; and/or,
receiving touch information inputted and converting the touch information into a corresponding control command, by the remote controller; and/or,
receiving voice information inputted and converting the voice information into a corresponding control command, by the remote controller.

11. The system for controlling a smart TV and a set-top box according to claim 2, wherein the remote controller comprises a posture chip for receiving posture information inputted and converting the posture information into a corresponding control command.

12. The system for controlling a smart TV and a set-top box according to claim 3, wherein the remote controller comprises a posture chip for receiving posture information inputted and converting the posture information into a corresponding control command.

13. The system for controlling a smart TV and a set-top box according to claim 2, wherein the remote controller comprises a touch chip for receiving touch information inputted and converting the touch information into a corresponding control command.

14. The system for controlling a smart TV and a set-top box according to claim 3, wherein the remote controller comprises a touch chip for receiving touch information inputted and converting the touch information into a corresponding control command.

15. The system for controlling a smart TV and a set-top box according to claim 2, wherein the remote controller comprises a microphone for receiving voice information inputted and converting the voice information into a corresponding control command.

16. The system for controlling a smart TV and a set-top box according to claim 3, wherein the remote controller comprises a microphone for receiving voice information inputted and converting the voice information into a corresponding control command.

17. The method for controlling a smart TV and a set-top box according to claim 8, wherein receiving the control command inputted, by the remote controller, comprises:
receiving posture information inputted and converting the posture information into a corresponding control command, by the remote controller; and/or,
receiving touch information inputted and converting the touch information into a corresponding control command, by the remote controller; and/or,
receiving voice information inputted and converting the voice information into a corresponding control command, by the remote controller.

18. The method for controlling a smart TV and a set-top box according to claim 9, wherein receiving the control command inputted, by the remote controller, comprises:
receiving posture information inputted and converting the posture information into a corresponding control command, by the remote controller; and/or,
receiving touch information inputted and converting the touch information into a corresponding control command, by the remote controller; and/or,
receiving voice information inputted and converting the voice information into a corresponding control command, by the remote controller.
